(19) United States
(12) Patent Application Publication
(10) Pub. No.: US 2017/0371974 A1
(43) Pub. Date: Dec. 28, 2017

(54) METHOD FOR LOADING WEBPAGE, CLIENT AND PROGRAMMABLE DEVICE

(71) Applicant: Guangzhou UCWEB Computer Technology Co., Ltd., Guangzhou (CN)

(72) Inventors: Xiang Liu, Guangzhou (CN); Zhiming Liu, Guangzhou (CN)

(21) Appl. No.: 15/628,686

(22) Filed: Jun. 21, 2017

(30) Foreign Application Priority Data
Jun. 22, 2016 (CN) 201610474667.4

(51) Int. Cl. G06F 17/30

(52) U.S. Cl. CPC G06F 17/30899; G06F 17/30864; G06F 17/30861; G06F 17/30902

(57) ABSTRACT

The present invention discloses a method for loading a webpage, a client and a programmable device. The method for loading a webpage comprises: in response to a request for loading a target webpage, loading the main document and the first-screen resource of the target webpage from the webpage server according to first-screen resource information of the target webpage which has been acquired; and loading the first-screen resource to a corresponding position of the main document. According to the present invention, the time for loading the first-screen resource of the webpage can be shortened.

### TECHNICAL FIELD

The present invention relates to the field of Internet, and more specifically, to a method for loading a webpage, a client and a programmable device.

### BACKGROUND ARTS

It is a fundamental application demand for Internet users to access a webpage via the Internet. With development of the Internet technology, requirements by Internet users on the speed of accessing a webpage become stricter and stricter. The speed of loading a webpage is an important index of the speed of accessing the webpage. Depending on the webpage content loading condition that can be perceived by the Internet user, the speed of loading the webpage is assessed by times T0, T1, T2 and T3, wherein T0 refers to a time period from initiation of a request for the webpage access to presentation of the webpage title, T1 refers to a time period from initiation of the request for the webpage access to presentation of the first line webpage content, T2 refers to a time period from initiation of the request for the webpage access to presentation of the first-screen content of the webpage (the webpage content on the first screen), and T3 refers to a time period from initiation of the request for the webpage access to presentation of the entire content of the webpage. Since at present, webpage content is generally very long, while the electronic device used by the user for accessing the webpage (e.g., a mobile phone, a tablet computer, or the like) has a display area with a limited size, usually the webpage accessed by the user is displayed in multiple screens, wherein the first-screen content of the webpage is displayed first, and a scroll button or scroll bar is provided for the user to browse the remaining content of the webpage. According to a survey on webpage-accessing habits of Internet users, most of the users accessing a webpage only pay attention to the first-screen content of the webpage, and just few users would operate the scroll button or scroll bar to the end of the webpage to view the entire webpage. Hence, T2 which is a time period from initiation of the request for the webpage access to presentation of the first-screen content of the webpage is more important than T0, T1 and T3 as an index for assessing the webpage loading speed.

At present, a method for loading a webpage is generally as follows: the client requests the webpage server to load a target webpage the user requests to access; the webpage server returns the main document of the target webpage to the client; the client parses the main document of the target webpage, and determines the resources contained in the target webpage that need to be loaded to the webpage server; and the client loads to the webpage server the resources contained in the target webpage. However, the inventors found that based on the current method for loading a webpage, it is necessary to load and parse the main document of the target webpage in order to load the resources contained in the corresponding webpage. In this case, even if only the first-screen content is loaded for display, it is still necessary to load and parse the main document of the target webpage in order to load the resources contained in the first-screen content, thereby having a relatively long time of T2.

Thus, in the inventors' opinion, it is necessary to make improvements to solve the problem existing in the prior art.

### DISCLOSURE OF THE INVENTION

It is an object of the present invention to provide a new technical solution for loading a webpage.

According to a first aspect of the present invention, a method for loading a webpage is provided, which comprises the steps of:

in response to a request for loading a target webpage, loading the main document and the first-screen resource of the target webpage from a webpage server according to first-screen resource information of the target webpage which has been acquired, the first-screen resource information being used for identifying the first-screen resource of the target webpage; and

loading the first-screen resource to a corresponding position in the main document.

In an embodiment, the step of loading the main document and the first-screen resource of the target webpage from the webpage server comprises:

transmitting a request for the target webpage to the webpage server, and transmitting a request for the first-screen resource of the target webpage to the webpage server according to locally stored first-screen resource information of the target webpage; and

receiving the main document and the first-screen resource of the target webpage returned from the webpage server.

Optionally, the request for the target webpage includes the request for the first-screen resource of the target webpage.

Optionally, the first-screen resource information is included in an HTML hyperlink tag directed to the target webpage, and the request for the target webpage is transmitted in response to a click on an HTML hyperlink corresponding to the HTML hyperlink tag.

In another embodiment, the step of loading the main document and the first-screen resource of the target webpage from the webpage server comprises:

transmitting a request for the target webpage to the webpage server to trigger the webpage server to return the first-screen resource of the target webpage according to first-screen resource information of the target webpage locally stored in the webpage server while returning the main document of the target webpage; and

receiving the main document and the first-screen resource of the target webpage returned from the webpage server.

Optionally, the method further comprises the step of, prior to responding to the request for loading the target webpage, acquiring the first-screen resource information of the target webpage and storing it.

Optionally, the first-screen resource information includes the resource address, resource type of the first-screen resource and a webpage identifier corresponding to the first-screen resource.

Optionally, the first-screen resource information is included in an HTML tag or a file in a designated format.

According to a second aspect of the present invention, a method for generating a webpage is provided, which comprises:

in response to a request for generating a webpage, generating a corresponding webpage; and

according to predetermined conditions, defining the first-screen resource of the generated webpage to generate first-screen resource information of the webpage, the first-screen resource information being used for identifying the first-screen resource of the webpage.

Optionally, the method further comprises storing the first-screen resource information of the webpage in a webpage server.

Optionally, the method further comprises in response to the request for the first-screen resource information of the webpage or according to a rule for returning the first-screen resource information of the webpage, returning the first-screen resource information.

Optionally, the first-screen resource information includes the resource address, resource type of the first-screen resource and a webpage identifier of the webpage corresponding to the first-screen resource.

Optionally, the first-screen resource information is included in an HTML tag or a file in a designated format.

According to a third aspect of the present invention, a client for loading a webpage is provided, which comprises:

a resource loading unit for, in response to a request for loading the target webpage, loading the main document and the first-screen resource of a target webpage from a webpage server according to first-screen resource information of the target webpage which has been acquired, the first-screen resource information being used for identifying the first-screen resource of the target webpage; and

a first screen loading unit for loading the first-screen resource to a corresponding position in the main document.

Optionally, the resource loading unit includes:

means for transmitting a request for the target webpage to the webpage server, and for transmitting a request for the first-screen resource of the target webpage to the webpage server according to locally stored first-screen resource information of the target webpage; and

means for receiving the main document and the first-screen resource of the target webpage returned from the webpage server.

Optionally, the request for the target webpage includes the request for the first-screen resource of the target webpage.

Optionally, the first-screen resource information is included in an HTML hyperlink tag directed to the target webpage, and the request for the target webpage is transmitted in response to a click on an HTML hyperlink corresponding to the HTML hyperlink tag.

Optionally, the resource loading unit includes:

means for transmitting a request for the target webpage to the webpage server, to trigger the webpage server to return the first-screen resource of the target webpage according to locally stored first-screen resource information of the target webpage, while returning the main document of the target webpage;

and

means for receiving the main document and the first-screen resource of the target webpage returned from the webpage server.

Optionally, the client further comprises means for acquiring first-screen resource information of the target webpage and storing it prior to responding to the request for loading the target webpage as received.

Optionally, the first-screen resource information includes the resource address, resource type of the first-screen resource and a webpage identifier corresponding to the first-screen resource.

Optionally, the first-screen resource information is included in an HTML tag or a file in a designated format.

According to a fourth aspect of the present invention, a webpage server for loading a webpage is provided, comprising means for returning the main document and the first-screen resource of a target webpage in response to a request for the target webpage as received and a request for the first-screen resource of the target webpage.

Optionally, the webpage server further comprises:

means for storing first-screen resource information of the target webpage; and

means for returning the first-screen resource of the target webpage according to the stored first-screen resource information of the target webpage.

According to a fifth aspect of the present invention, a device for generating a webpage is provided, comprising:

a webpage generating unit for generating a corresponding webpage in response to a request for generating a webpage; and

a first-screen resource information generating unit for defining the first-screen resource of the generated webpage according to predetermined conditions to generate first-screen resource information of the webpage, the first-screen resource information being used for identifying the first-screen resource of the webpage.

Optionally, the device further comprises:

means for storing the first-screen resource information of the webpage in a webpage server.

Optionally, the device further comprises:

means for returning the first-screen resource information in response to a request for the first-screen resource information of a webpage or according to a rule for returning the first-screen resource information of the webpage.

Optionally, the first-screen resource information includes the resource address, resource type of the first-screen resource and a webpage identifier of a webpage corresponding to the first-screen resource.

Optionally, the first-screen resource information is included in an HTML tag or a file in a designated format.

According to a sixth aspect of the present invention, a webpage server is provided, which comprises a device for generating a webpage as provided according to the fifth aspect of the present invention.

According to a seventh aspect of the present invention, a programmable device is provided, comprising a memory and a processor, wherein the memory is used for storing instructions for controlling the processor to operate to perform a method for loading a webpage according to any one provided by the first aspect of the present invention.

According to an eighth aspect of the present invention, a programmable device is provided, comprising a memory and a processor, wherein the memory is used for storing instructions for controlling the processor to operate to perform a method for generating a webpage according to any one provided by the second aspect of the present invention.

The inventors of the present invention found that no method for webpage loading, no client, no webpage server or programmable device exists in the prior art by which when loading a webpage, it is unnecessary to load and parse the main document of the webpage in order to start loading the first-screen resource of the webpage. Thus, the technical task to be fulfilled or the technical problem to be solved by the present invention has never been envisaged or expected by those skilled in the art, so the present invention is a novel technical solution.

Illustrative examples of the present invention are described in detail below with reference to the figures, by which other features and advantages of the present invention will become clear.

### DESCRIPTION ON THE FIGURES

The figures combined in the description and forming a part of the description illustrate examples of the present invention, and the figures together with their descriptions are used for interpreting the principle of the present invention.

FIG. 1 is a schematic diagram illustrating an environment in which the examples of the present invention are implemented.

FIG. 2 is a flow chart illustrating a method for loading a webpage in the first embodiment of the present invention.

FIG. 3 is a schematic block diagram illustrating a device for loading a webpage in the first embodiment of the present invention.

FIG. 4 is a flow chart illustrating a method for generating a webpage in the second embodiment of the present invention.

FIG. 5 is a schematic block diagram illustrating a device for generating a webpage in the second embodiment of the present invention.

### EMBODIMENT

Various illustrative examples of the present invention are described in detail now with reference to the figures. It is to be noted that unless otherwise specified, relative arrangements of the components and steps, numerical expressions and values illustrated in these examples are not limited within the range of the present invention.

The following descriptions on at least one illustrative example are actually just descriptive, and shall by no means set any limit on the present invention and its applications or utilizations.

Techniques, methods and devices that have already been known to those skilled in the art may not be discussed in detail, but under proper circumstances, said techniques, methods and devices shall be regarded as a part of the description.

In all the examples shown and discussed here, any specific value shall be interpreted as only illustrative instead of limitative. Hence, other examples of the illustrative embodiments may have different values.

It is to be noted that similar numbers and letters represent similar items in the following figures. Therefore, once a certain item is defined in one figure, it is not necessary to further discuss it in the subsequent figures.

<Hardware Configurations>

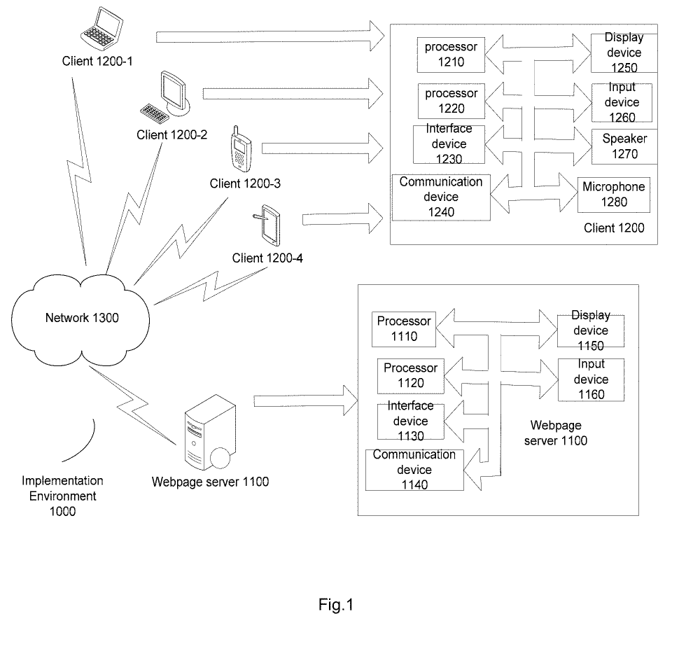

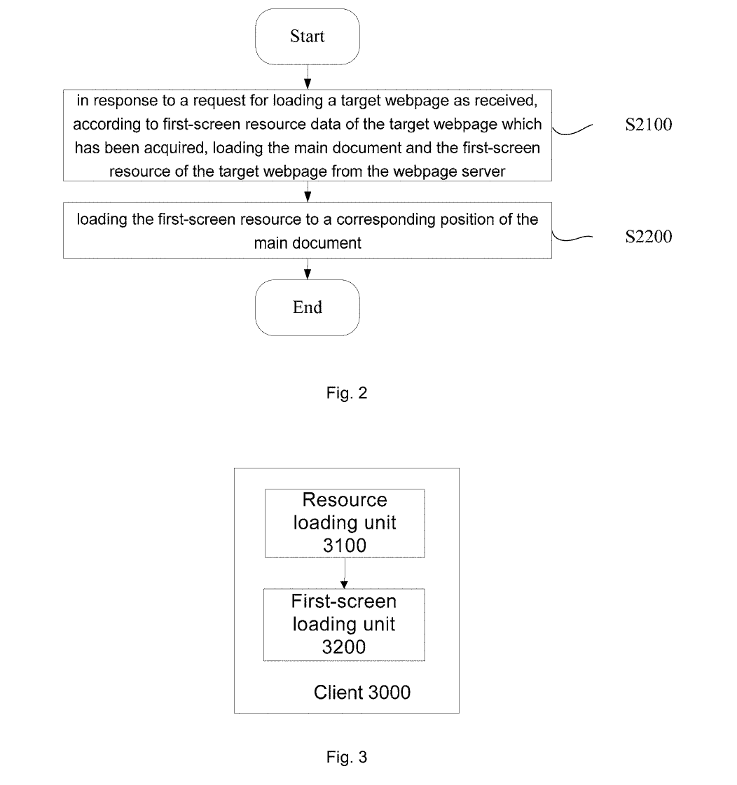

FIG. 1 is a schematic diagram illustrating an implementation environment 1000 for the embodiments of the present invention.

As shown in FIG. 1, the implementation environment 1000 includes a webpage server 1100, a client 1200 and a network 1300.

The webpage server 1100, for example, can be a blade server, or the like. In one example, the server 1100 may be a desktop computer. In another example, the server 1100 may, as shown in FIG. 1, comprise a processor 1110, a memory 1120, an interface device 1130, a communication device 1140, a display device 1150 and an input device 1160. The server may also comprise a speaker, a microphone and the like, but such components are irrelevant to the present invention and therefore are omitted here. The processor 1110, for example, may be a central processor CPU, a microprocessor MCU, or the like. The memory 1120, for example, comprises an ROM (read-only memory), an RAM (random access memory), a nonvolatile memory such as a hard disc, and the like. The interface device 1130, for example, comprises a USB interface, a serial interface, and the like. The communication device 1140, for example, can perform wired or wireless communications. The display device 1150, for example, is a liquid crystal display screen. The input device 1160, for example, may comprise a touch screen, a keyboard, and the like.

The client device 1200 may be a portable computer (1200-1), a desktop computer (1200-2), a mobile phone (1200-3), a tablet computer (1200-4), etc. As shown in FIG. 1, the client 1200 may comprise a processor 1210, a memory 1220, an interface device 1230, a communication device 1240, a display device 1250, an input device 1260, a speaker 1270, a microphone 1280, and so on. The processor 1210 may be a central processor CPU, a microprocessor MCU, or the like. The memory 1220, for example, comprises an ROM (read-only memory), an RAM (random access memory), a nonvolatile memory such as a hard disc, and the like. The interface device 1230, for example, comprises a USB interface, an earphone interface, and the like. The communication device 1240, for example, can perform wired or wireless communications. The display device 1250, for example, is a liquid crystal display screen, a touch display screen, or the like. The input device 1260, for example, may comprise a touch screen, a keyboard, and the like. The user may input/output voice messages via the speaker 1270 and the microphone 1280.

The communication network 1300 may be a wireless network or a wired network, may be a local area network or a wide area network. In the configuration environment 1000 as shown in FIG. 1, clients 1200-1, 1200-2, 1200-3, 1200-4 and the webpage server 1100 may communicate via the communication network 1300.

The configuration environment 1100 as shown in FIG. 1 is only interpretative, and by no means is to limit the present invention, its applications or utilizations. Applied to the embodiments of the present invention, the memory 1120 of the webpage server 1100 is used for storing instructions that are configured to control the processor 1110 to operate to perform any method for loading a webpage or for generating a webpage as provided in the embodiments of the present invention. In addition, the memory 1220 of the client 1200 is used for storing instructions that are configured to control the processor 1210 to operate to perform any method for loading a webpage as provided in the embodiments of the present invention. Those skilled in the art should understand that although a plurality of devices are shown for the webpage server 1100 and the client 1200 in FIG. 1, the present invention may relate only to a part of the devices thereof. For example, the webpage server 1100 only relates to the processor 1110 and the storage device 1120, or the client 1200 only relates to the processor 1210 and the storage device 1220, etc. Those skilled in the art may design instructions according to the solution disclosed in the present invention. It is common knowledge in the art how the instructions control the processor for the operation, so it will not be described in detail here.

### First Embodiment

According to a first embodiment of the present invention, a method for loading a webpage is provided, which comprises the following steps:

Step S2100, in response to a request for loading a target webpage as received, according to first-screen resource information of the target webpage which has been acquired, loading the main document and the first-screen resource of the target webpage from a webpage server, the first-screen resource information being used for identifying the first-screen resource of the target webpage.

Generally speaking, the request for loading the target webpage includes a webpage identifier (such as a URL, Uniform Resource Locator) of the target webpage that is requested for loading. The webpage server may acquire and return the main document of the target webpage according to the webpage identifier of the target webpage. The main document of the target webpage is a document describing the main body frame of the target webpage. For example, for a webpage based on the HTML technique, the main document is generally an HTML document that conforms to the HTML standard (see) https://www.w3.org/html/). The main body frame of the webpage may be resources contained in the webpage and corresponding attributes, including, for example, the location where the resources are stored, the height and width of the display area, the layout information, etc. The resources contained in the webpage can be learnt by parsing the main document of the webpage. In a current webpage loading process, only after the main document of the webpage is loaded and parsed to learn the resources contained in the webpage can the loading of the resources in the corresponding webpage start. However, in step S2100 of the webpage loading method according to the present embodiment, it is unnecessary to load and parse the main document of the target webpage before starting to load resources of the webpage (in particular the first-screen resource of the webpage).

In this embodiment, the first-screen resource of the webpage may be key resources contained in the first-screen content of the webpage. For example, the first-screen resource of the webpage may be the resource in the first-screen content that costs a long time to load. For example, according to a statistical result on the contents of existing Internet webpages, pictures contained in a webpage averagely occupy 60% in size of the entire webpage content; correspondingly, if pictures are contained in the first-screen content, the time spent on loading the pictures is relatively long, and the first-screen resource may be defined as pictures in the first-screen content. More specifically, the first-screen resource may be defined as the first picture or the largest picture in the first-screen content. Alternatively, the first-screen resource of a webpage may be a resource that cannot be loaded and cached to the client of the webpage but has to be acquired from the webpage server, such as, for example, certain css (Cascading Style Sheets) resources or js (JavaScript) resources. In addition, in this embodiment, the first-screen resource may be a single resource or include multiple resources, and may be multiple resources of the same resource type or multiple resources of different resource types. In this embodiment, the number of resources contained in or the resource type of the first-screen resource is not specifically delimited, and the specific number of resources contained in or the resource type of the first-screen resource can be determined according to the specific application scenario or other self-defined demands.

The first-screen content of a webpage is generally the webpage content obtained by division of the entire content of the webpage according to the visible area of a client device (such as a mobile phone, a tablet computer) used by the user for loading the webpage or a client application (such as a browser) used by the user for loading the webpage and displayed in the visible area for the first time. Generally speaking, the first-screen content of a webpage may be divided by the webpage server according to parameters of the visible area carried in the webpage request during the process of loading the webpage, or may be divided by the webpage server according to estimated parameters of the visible area during the process of generating the webpage, or may also be divided according to the demand on the application scenario. For example, in an application scenario where the webpage can be displayed only after loading the entire webpage or in an application scenario where the entire webpage can be displayed in the visible area, the first-screen content of the webpage may be the entire content of the webpage.

In this embodiment, the method for dividing the first-screen content of the target webpage is not limited. Correspondingly, the method for defining the first-screen resource of the target webpage is not limited, as long as the attribute information on the first-screen resources of the target webpage has been acquired before responding to the request for loading the target webpage as received. By the first-screen resource information of the target webpage which has been acquired, when responding to the request for loading the target webpage, the main document and the first-screen resource of the target webpage may be loaded from the webpage server, and it is unnecessary to load and parse the main document of the target webpage in order to start loading the first-screen resource of the webpage, thereby shortening the time spent on loading the first-screen resource of the target webpage. That is, the time T2 (a time period from initiation of a request for accessing the webpage to presentation of the first-screen content of the webpage) is shortened. In this case, the webpage loading performance is enhanced. In some examples, the first-screen resources of the target webpage are local resources that have been cached in a device for loading the target webpage (e.g., certain css resources or js resources), and thus, when loading the target webpage, it is not only unnecessary to load and parse the main document of the webpage before loading the first-screen resource, but also unnecessary to load the first-screen resource from the webpage server, thereby further shortening the time T2.

In one example, the method for loading a webpage provided in the embodiment further comprises: prior to responding to the request for loading the target webpage as received, acquiring first-screen resource information of the target webpage and storing it. For example, after the webpage server generates a webpage and defines the first-screen resource of the webpage, it generates corresponding first-screen resource information and stores it locally in the webpage server. For another example, after the webpage server generates a webpage and defines the first-screen resource of the webpage and then generates corresponding first-screen resource information, it transmits the data to a device for implementing the method for loading a webpage according to this embodiment (such as a client), and the device stores the data locally in it. For another example, according to predetermined periodic requests (e.g. periodic requests for first-screen resources of a webpage generated under a demand for an automatic subscription of a headline news webpage) or in response to an external operation, the device for implementing the method for loading a webpage according to this embodiment requests to the webpage server generating the first-screen resource information of the webpage the first-screen resource information that has been most recently generated and then stores it locally in the device.

In another example, the first-screen resource information of the target webpage can be provided in association with an identification information (i.e. URL) of the target webpage. When a request for the target webpage based on the identification information is generated and sent out, a request for the first-screen resource of the target webpage, based on the first-screen resource information, can be generated and sent out as well.

The two requests can be separately generated and sent out. However, it might be better if the request for the first-screen resource of the target webpage is included in the request for the target webpage. In other words, the request for the target webpage can include both the identification information (i.e. URL) and the first-screen resource information of the target webpage, and requests for both the main document and the first-screen resource.

Further, an HTML hyperlink directed to the target webpage can be provided in a page, i.e. a webpage or a page in an App. The first-screen resource information and the identification information (i.e. URL) of the target webpage can be both included in an HTML hyperlink tag corresponding to the HTML hyperlink, and thus provided in association with each other.

As an example, the HTML hyperlink tag can be an “a” tag like the following one:

<a
href=“http://example.com/index.html”
first-screen-data=”http://image.example.com/1.jpg”>.

In such an “a” tag, the attribute “herf” defines the identification information (i.e. URL) of the target webpage, and the attribute “first-screen-data” defines the first-screen resource information.

In response to a click on such an HTML hyperlink corresponding to such an “a” tag, the request for the target webpage, as well as the request of the first-screen resource, will be transmitted.

In this embodiment, the attribute information on the first-screen resource of the target webpage is used for identifying the first-screen resource of the target webpage. In one example, the first-screen resource information of the webpage may be the resource address, resource type of the first-screen resource and a webpage identifier corresponding to the first-screen resources. The resource type of the first-screen resource may be CSS, JS or pictures. The resource address is a specific address where the first-screen resource is stored. The webpage identifier corresponding to the first-screen resource is an identifier of the webpage where the first-screen content to which the first-screen resource belongs is located, such as a URL of the webpage.

In this embodiment, the first-screen resource information of the target webpage may be stored locally in the device for implementing the method for loading the webpage (e.g. a client), or may be stored by the webpage server locally in the server. The form in which the first-screen resource information is stored can be diversified. In one example, the first-screen resource information may be contained in a file in a designated format. The designated format of the file may be a text format (for example, txt, xml, html, etc.), a database format (for example, SQLite, NoSQL), or a self-defined format. In another example, the target webpage is an HTML webpage, in which a plurality of HTML tags are included. The first-screen resource information of the target webpage may be contained in the HTML tags. For example, an HTML tag link of a certain HTML target webpage contains first-screen resource information, first-screen-data (the first-screen resource is a picture in the jpg format):

<a
href=“http://example.com/index.html”
first-screen-data=”http://image.example.com/1.jpg”>.

In this example in which the HTML tag link contains the first-screen resource information, first-screen-data, if the first-screen resource includes multiple resources, first-screen-data contains a list of data corresponding to the multiple resources, data on each resource being similar to the data on the picture in the jpg format as mentioned in the above example, et cetera, which will not be repeated here.

In another example, the first-screen resource information of the target webpage has been pre-stored locally in the device for implementing the method for loading the webpage (such as a client). When responding to the request for loading the target webpage, a request for the first-screen resource of the target webpage may be transmitted to the server according to the locally stored first-screen resource information when transmitting a request for loading the main document of the target webpage to the webpage. In this way, it is unnecessary to wait for the loading and parsing of the main document of the target webpage in order to load the first-screen resource of the target webpage, thereby shortening the time spent on loading the first-screen resource of the target webpage, i.e., shortening the time T2, and enhancing the webpage loading performance. Therefore, in step S2100, the step of loading the main document and the first-screen resource of the target webpage from the webpage server comprises:

transmitting a request for the target webpage to the webpage server, and according to the locally stored first-screen resource information of the target webpage, transmitting a request for the first-screen resource of the target webpage to the server, and

receiving the main document and the first-screen resource of the target webpage returned from the webpage server.

In this example, the request for the target webpage may contain a request for the first-screen resource of the target webpage. The webpage server is triggered by one request to return the main document and the first-screen resource of the target webpage, thereby reducing the times for the transmission of request messages, and further shortening the time for loading the first-screen resource of the target webpage, i.e., shortening the time T2, and enhancing the webpage loading performance.

As mentioned above, the first-screen resource information can be included in an HTML hyperlink tag directed to the target webpage. The request for the target webpage, including the first-screen resource information (or, the request for the first-screen resource), can be transmitted in response to a click on an HTML hyperlink corresponding to the HTML hyperlink tag.

In another example, the first-screen resource information of the target webpage has been pre-stored locally in the webpage server. When a request for the target webpage is transmitted to the webpage server to trigger the webpage server to return the main document of the target webpage, the first-screen resource of the target webpage may be returned according to the locally stored first-screen resource information of the target webpage, without the necessity to wait for the loading and parsing of the main document of the target webpage in order to load the first-screen resource of the target webpage, thereby shortening the time spent on loading the first-screen resource of the target webpage, i.e., shortening the time T2, and enhancing the webpage loading performance. Thus, in step S2100, the step of loading the main document and the first-screen resource of the target webpage from the webpage server comprises:

transmitting a request for the target webpage to the webpage server to trigger the webpage server to return the first-screen resource of the target webpage according to the locally stored first-screen resource information of the target webpage when returning the main document of the target webpage; and

receiving the main document and the first-screen resource of the webpage returned from the webpage server.

After performing step S2100 according to any example as provided above, proceeding to step S2200 to load the first-screen resource to a corresponding position in the main document.

According to any webpage loading method provided in this embodiment, when the main document of the target webpage is loaded from the webpage server, the first-screen resource of the target webpage is also loaded, and it is unnecessary to wait for the webpage server to return the main document of the target webpage to be loaded and parse the main document in order to start loading the resource of the target webpage, thereby shortening the time for loading the first-screen resource. Correspondingly, the time T2 is shortened. Thus, the webpage loading performance is enhanced. In addition, in certain scenarios, the first-screen content of a webpage is the entire content of the webpage, and corresponding first-screen resource is the key resource contained in the entire content of the webpage. In this case, by performing any webpage loading method provided in this embodiment, not only the time T2 but also the time T3 (a time period from initiation of the request for accessing the webpage to presentation of the entire content of the webpage) is shortened.

In this embodiment, a client 3000 for loading the webpage is further provided. As shown in FIG. 3, the client 3000 comprises a resource loading unit 3100 and a first-screen loading unit 3200, and is used for implementing any webpage loading method provided in this embodiment, which will not be repeated here.

A client 3000 for loading a webpage, comprising:

a resource loading unit 3100 for, in response to a request for loading a target webpage, loading the main document and the first-screen resource of the target webpage from a webpage server according to the first-screen resource information of the target webpage which has been acquired, the first-screen resource information being used for identifying the first-screen resource of the target webpage; and

a first-screen loading unit 3200 for loading the first-screen resource to a corresponding position in the main document.

In one example, the resource loading unit 3100 comprises:

means for transmitting a request for the target webpage to the webpage server, and for requesting the webpage server to load the first-screen resource of the target webpage according to the locally stored first-screen resource information of the target webpage; and

means for receiving the main document and the first-screen resource of the target webpage returned from the webpage server.

Optionally, the request for the target webpage includes the request for the first-screen resource of the target webpage.

Optionally, the first-screen resource information can be included in an HTML hyperlink tag directed to the target webpage, and the request for the target webpage is transmitted in response to a click on an HTML hyperlink corresponding to the HTML hyperlink tag.

In another example, the resource loading unit 3100 comprises:

means for transmitting a request for the target webpage to the webpage server, to trigger the webpage server to return the first-screen resource of the target webpage according to locally stored first-screen resource information of the target webpage, while returning the main document of the target webpage; and

means for receiving the main document and the first-screen resource of the target webpage returned from the webpage server.

In a further example, the client 3000 further comprises:

means for acquiring and storing the first-screen resource information of the target webpage before responding to the received request for loading the target webpage.

In one example, the first-screen resource information includes the resource address, resource type of the first-screen resource and a webpage identifier corresponding to the first-screen resource.

In a further example, the first-screen resource information is included in an HTML tag or a file in a designated format.

In this embodiment, a webpage server for loading a webpage is further provided for implementing any webpage loading method provided in this embodiment, which will not be repeated here. The webpage server comprises means for returning the main document and the first-screen resource of the target webpage in response to the received request for the target webpage and the request for the first-screen resource of the target webpage.

In one example, the webpage server further comprises:

means for storing the first-screen resource information of the target webpage; and

means for returning the first-screen resource of the target webpage according to the stored first-screen resource information of the target webpage.

In this embodiment, the specific implementation form of the client 3000 for loading the webpage can be diversified, which may be a browser, or a program for loading a webpage, such as an application on the mobile phone that is capable of subscribing the headlines. As long as being able to be used for implementing any webpage loading method provided in this embodiment, an implementation form belongs to an implementation form of the client 3000 according to this embodiment.

In this embodiment, a programmable device is further provided, comprising a memory and a processor, wherein the memory is used for storing instructions for controlling the processor to operate to perform any method for loading a webpage provided in this embodiment.

In this embodiment, a non-transitory machine-readable storage medium is further provided. Executable codes are stored on the non-transitory machine-readable storage medium. When the executable codes are executed by a processor of an electronic device, the processor is caused to perform the method for loading a webpage as described in this embodiment. The first embodiment of the present invention has been described hereinabove with reference to the figures. According to this embodiment, a webpage loading method, a client, a webpage server and a programmable device are provided, in which, according to the first-screen resource information of the target webpage which has been acquired before loading the target webpage, the main document and the first-screen resource of the target webpage are loaded from the webpage server while the target webpage is loaded, without the necessity of loading and parsing the main document of the target webpage before starting loading the first-screen resource of the webpage, thereby shortening the time spent on loading the first-screen resource of the target webpage. Accordingly, the time T2 is shortened, and the webpage loading performance is enhanced.

### Second Embodiment

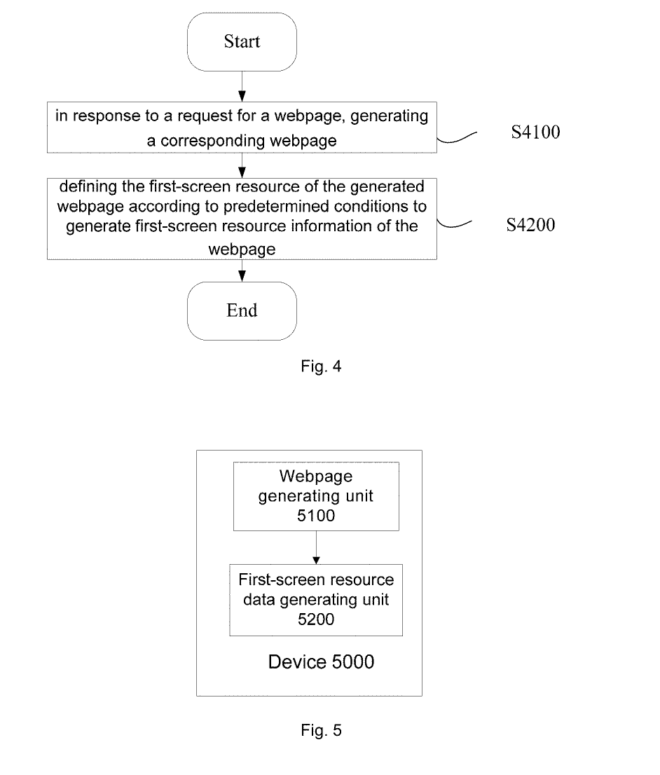

According to a second embodiment of the present invention, a method for generating a webpage is provided, which, as shown in FIG. 4, comprises:

Step S4100, in response to a request for generating a target webpage, generating a corresponding webpage;

Step S4200, defining the first-screen resource of the generated webpage according to predetermined conditions to generate first-screen resource information of the webpage, the first-screen resource information being used for identifying the first-screen resource of the webpage.

In this embodiment, during the process of generating the webpage, the first-screen resource of the generated webpage is defined according to predetermined conditions. The predetermined conditions defining the first-screen resource of the webpage can be determined according to the application scenario of the webpage, the demand of the target user accessing the webpage, the design demand of the developers developing the webpage, and so on.

For example, in certain application scenarios, the first-screen resource of a webpage is the key resource contained in the first-screen content of the webpage. More specifically, the predetermined conditions may define the first-screen resource of a webpage as the resource in the first-screen content that costs a long time for its loading. For example, according to a statistical result on the contents of the existing Internet webpages, pictures contained in a webpage averagely occupy 60% in size of the entire webpage content; correspondingly, if pictures are contained in the first-screen content, the time spent on loading the pictures is relatively long, and in the predetermined conditions, the first-screen resource may be defined as pictures in the first-screen content. In a specific example, the predetermined conditions may be, the first-screen resource of the webpage is the first picture or the largest picture in the first-screen content. Alternatively, the predetermined conditions may be, the first-screen resource of a webpage is a resource that cannot be loaded and cached to the client loading the webpage but has to be acquired from the webpage server, such as, for example, certain css (Cascading Style Sheets) resources or js (JavaScript) resources. In addition, in this embodiment, the first-screen resource may be a single resource or include multiple resources, and may be multiple resources of the same resource type or multiple resources of different resource types. In this embodiment, the number of resources contained in or the resource type of the first-screen resources is not specifically delimited, and the specific number of resources contained in or the resource type of the first-screen resources can be determined according to the specific application scenario or other self-defined demands.

The above-mentioned illustrative predetermined conditions defining the first-screen resource of a webpage relate to first-screen content of the webpage. However, the first-screen content of a webpage generally refers to the webpage content obtained by division of the entire content of the webpage according to a visible area of a client device used by the user for loading the webpage (e.g., a mobile phone, a tablet computer) or a client application used by the user for loading the webpage (e.g., a browser) and displayed in the visible area for the first time. The first-screen content of the webpage may be divided by the device generating the webpage during the process of generating the webpage according to estimated parameters of the visible area, or may be divided by the device generating the webpage according to parameters of the visible area that are obtained in advance, and further, may be divided according to the demand of the application scenario. For example, in an application scenario in which the webpage is displayed only after loading the entire webpage or in an application scenario in which the visible area can display the entire webpage, the first-screen content of the webpage is the entire content of the webpage. In this embodiment, the rule for the division of the first-screen content of the target webpage is not delimited, as long as when implementing the method for generating a webpage provided in this embodiment, before defining the first-screen resource of the webpage according to predetermined conditions that shall relate to the first-screen content of the webpage, the first-screen content of the webpage has been determined.

In this embodiment, the attribute information on the first-screen resource of the target webpage is used for identifying the first-screen resource of the target webpage. In one example, the first-screen resource information of the webpage can be the resource address, resource type of the first-screen resource and a webpage identifier corresponding to the first-screen resource. The resource type of the first-screen resource may be CSS, JS or pictures. The resource address is a specific address where the first-screen resource is stored. The webpage identifier corresponding to the first-screen resource is an identifier of the webpage where the first-screen content to which the first-screen resource belongs is located, such as a URL of the webpage.

In one example, the method for generating a webpage further comprises: storing the first-screen resource information of the webpage in the webpage server. The webpage server may be a webpage server for generating the webpage, or a webpage server for responding to a request for loading the webpage. In certain application scenarios, the webpage server for generating the webpage and the webpage server for responding to the request for loading the webpage may be a single server in entity. The form in which the first-screen resource information is stored can be diversified. In one example, the first-screen resource information may be contained in a file in a designated format. The designated format of the file may be a text format (for example, txt, xml, html, etc.), a database format (for example, SQLite, NoSQL), or a self-defined format. In another example, the target webpage is an HTML webpage, in which a plurality of HTML tags are included. The first-screen resource information of the target webpage may be contained in the HTML tags. For example, an HTML tag link of a certain HTML target webpage contains the first-screen resource information, first-screen-data (the first-screen resource is a picture in the jpg format):

<a
href=”http://example.com/index.html”
first-screen-data=”http://image.example.com/1.jpg”>.

In this example in which an HTML tag link of a certain HTML target webpage contains the first-screen resource information, first-screen-data, if the first-screen resource includes multiple resources, the first-screen-data contains a list of data on multiple resources, the data on each resource being similar to the data on the picture in the jpg format as mentioned in the above example, et cetera, which will not be repeated here.

In another example, the method for generating a webpage according to this embodiment further comprises, in response to a request for the first-screen resource information of a webpage or according to a rule for returning the first-screen resource information of the webpage, returning the first-screen resource information. For example, when a method for loading a webpage according to the first embodiment of the present invention is implemented, before loading the target webpage, the first-screen resource information of the target webpage must have been acquired. Then, a request for the first-screen resource information of the target webpage may be transmitted by a client for loading a webpage, and a device for implementing the method for generating a webpage according to this embodiment may return the first-screen resource in response to a request for the first-screen resource information. Further, for example, if the generated webpage is a webpage that is subscribed and accessed by the user (for example, an application scenario of subscribing daily headlines), after the webpage is generated, the first-screen resource corresponding to the generated webpage may be returned directly to the device for accessing the subscribed webpage, and correspondingly, the rule for returning the first-screen resource information of the webpage is to directly return the first-screen resource of the webpage after generating it. Alternatively, according to predetermined periods, the first-screen resource information of the webpage generated in the latest period or generated by updating is returned to the device for accessing the subscribed webpage, and correspondingly, the rule for returning the first-screen resource information is; according to the predetermined periods, to return the first-screen resource information of the webpage generated in the latest period or generated by updating. The rule for returning the first-screen resource information may also be set according to the practical demands of the application scenario, which will not be listed here.

According to any webpage generating method provided in this embodiment, it is possible to generate the first-screen resource information of the webpage when the webpage is generated, such that when the webpage is loaded, the first-screen resource of the webpage can be loaded directly according to the first-screen resource information of the webpage, and it is unnecessary to load from the webpage server the main document of the webpage and parse the main document before loading the first-screen resource of the webpage, thereby shortening the time spent on loading the first-screen resource of the target webpage. Correspondingly, the time T2 is shortened. Thus, the webpage loading performance is enhanced. In addition, in certain scenarios; the first-screen content of a webpage is the entire content of the webpage, and corresponding first-screen resource of the webpage is the key resource contained in the entire content of the webpage. In this case, the first-screen resource information of the webpage is generated when the webpage is generated by any webpage generating method provided in this embodiment, such that not only the time T2 but also the time T3 (a time period from initiation of the request for accessing the webpage to presentation of the entire content of the webpage) is shortened.

In this embodiment, a device 5000 for generating a webpage is further provided, which, as shown in FIG. 5, comprises a webpage generating unit 5100 and a first-screen resource information generating unit 5200, for implementing any method for generating a webpage provided in this embodiment, which will not be repeated here.

A device 5000 for generating a webpage, comprising:

a webpage generating unit 5100 for generating a corresponding webpage in response to a request for generating a webpage; and

a first-screen resource information generating unit 5200 for defining the first-screen resource of the generated webpage according to predetermined conditions to generate first-screen resource information of the webpage, the first-screen resource information being used for identifying the first-screen resource of the webpage.

In one example, the predetermined condition is that the first-screen resource of the webpage is the first picture in the first-screen content of the webpage.

In another example, the device 5000 in this embodiment further comprises means for storing the first-screen resource information of the webpage in a webpage server.

In a further example, the device 5000 in this embodiment further comprises means for returning the first-screen resource information in response to a request for the first-screen resource information of the webpage or according to a rule for returning the first-screen resource information of the webpage.

In a further example, the first-screen resource information includes the resource address, resource type of the first-screen resource and a webpage identifier of the webpage corresponding to the first-screen resource.

In a further example, the first-screen resource information is included in an HTML tag or a file in a designated format.

In this embodiment, a webpage server is further provided, which comprises a device 5000 for generating a webpage provided in this embodiment.

In this embodiment, a programmable device is further provided, which comprises a memory and a processor, wherein the memory is used for storing instructions for controlling the processor to operate to perform any method for generating a webpage provided in this embodiment.

In this embodiment, a non-transitory machine-readable storage medium is further provided. Executable codes are stored on the non-transitory machine-readable storage medium. When the executable codes are executed by a processor of an electronic device, the processor is caused to perform the method for generating a webpage as described in this embodiment.

The second embodiment of the present invention has been described hereinabove with reference to the figures. According to this embodiment, a webpage generating method, a device, a webpage server and a programmable device are provided, which can generate the first-screen resource information of the webpage when the webpage is generated, such that the first-screen resource of the webpage can be loaded directly according to the first-screen resource information of the webpage when the webpage is loaded, without the necessity of loading from the webpage server the main document of the webpage and parsing the main document before loading the first-screen resource of the webpage, thereby shortening the time spent on loading the first-screen resource of the target webpage. Accordingly, the time T2 is shortened, and the webpage loading performance is enhanced.

### Third Embodiment

According to the third embodiment, a method for generating a page is provided.

The page can be a webpage or a page in an App.

One or more HTML hyperlinks can be provided in the page. Each HTML hyperlink directs to a target webpage, and the HTML hyperlink tag corresponding to the HTML hyperlink includes the identification information (i.e. URL) of the target webpage.

In this embodiment, the first-screen resource information of a target webpage directed to by an HTML hyperlink is also included (added) in the HTML hyperlink tag corresponding to the HTML hyperlink. The first-screen resource and the first-screen resource information can be the same as those in the first and second embodiments. Some details are omitted here.

In other words, the identification information (i.e. URL) and the first-screen resource information of the target webpage are associated by being both included in one HTML hyperlink tag.

As an example, the HTML hyperlink tag can be an “a” tag like the following one:

<a
href=“http://example.com/index.html”
first-screen-data=”http://image.example.com/1.jpg”>.

In such an “a” tag, the attribute “herf” defines the identification information (i.e. URL) of the target webpage, and the attribute “first-screen-data” defines the first-screen resource information.

Such a page can be provided to the user by a web browser or another APP. In response to a click on the HTML hyperlink in the page, the request for the target webpage, as well as the request of the first-screen resource, will be transmitted.

Therefore, in the method for generating a page according to the third embodiment, an HTML hyperlink directed to the target webpage can be provided in the page; and then both the identification information (i.e. URL) and the first-screen resource information of the target webpage are added into the HTML hyperlink tag corresponding to the HTML hyperlink.

Further, the first-screen resource information of the target webpage can be defined and/or acquired before being added into the HTML hyperlink tag.

In this embodiment, a device for generating a page is further provided, which includes a hyperlink providing unit, and an identification information adding unit and a first-screen resource information adding unit.

The hyperlink providing unit provides an HTML hyperlink directed to the target webpage can be provided in the page. An HTML hyperlink tag corresponding to the HTML hyperlink will be added in the page document.

The identification information adding unit adds the identification information (i.e. URL) of the target webpage into the HTML hyperlink tag.

The first-screen resource information adding unit adds the first-screen resource information of the target webpage into the HTML hyperlink tag.

Further, the device for generating a page may also include a acquiring unit for acquiring the first-screen resource information of the target webpage, so that the first-screen resource information adding unit can add it into the tag.

In this embodiment, a server is further provided, which comprises a device for generating a page provided in this embodiment.

In this embodiment, a programmable device is further provided, which comprises a memory and a processor, wherein the memory is used for storing instructions for controlling the processor to operate to perform any method for generating a webpage provided in this embodiment.

In this embodiment, a non-transitory machine-readable storage medium is further provided. Executable codes are stored on the non-transitory machine-readable storage medium. When the executable codes are executed by a processor of an electronic device, the processor is caused to perform the method for generating a page as described in this embodiment.

The third embodiment of the present invention has been described hereinabove with reference to the figures. According to this embodiment, a page generating method, a device, a server and a programmable device are provided, which can incorporate both the identification information (i.e. URL) and the first-screen resource information of the target webpage in an HTML hyperlink tag, such that the first-screen resource of the webpage can be loaded directly according to the first-screen resource information of the webpage when the target webpage is loaded, without the necessity of loading from the webpage server the main document of the webpage and parsing the main document before loading the first-screen resource of the webpage, thereby shortening the time spent on loading the first-screen resource of the target webpage. Accordingly, the time T2 is shortened, and the webpage loading performance is enhanced.

Those skilled in the art should understand that the client 3000 and the device 5000 can be realized in various manners. For example, the client 3000 and the device 5000 of the webpage may be realized by configuring the processor with instructions. For example, instructions can be stored in an ROM, and when the device is started, the instructions are read from the ROM to a programmable device to realize the client 3000 and the device 5000 of the webpage. For example, the client 3000 and the device 5000 of the webpage are fixed onto a specific device (such as an ASIC). The client 3000 and the device 5000 of the webpage may be divided into units that are independent of one another, or alternatively, they may be combined together. The client 3000 and the device 5000 of the webpage may be realized by one of the above-mentioned manners, or by a combination of two or more of the above-mentioned various manners.

It is well known to those skilled in the art that with development of the electronic information technology such as large-scale integrated circuits and a tendency of turning software into hardware, it seems very difficult to separate software from hardware of the computer system, because any operation may be performed by software or by hardware, and any instruction may be executed by hardware or by software. Whether a certain machine function adopts a hardware realized solution or a software realized solution depends on non-technological factors including price, speed, reliability, storage capacity, change period, etc. Therefore, for those ordinary technicians in the technical field of electronic information, a method to describe a technical solution more directly and clearly is to describe the respective operations in the solution. Where the operations to be executed are known, those skilled in the art may directly design the desired product based on considerations of the non-technological factors.

The present invention may be a system, a method and/or a computer program product. For example, the client 3000, the webpage server and the device 5000 involved in the present invention may be computer products. The computer program product may include a computer-readable storage medium, which carries thereon computer-readable program instructions for causing the processor to realize the respective aspects of the present invention.

The computer-readable storage medium may be a tangible device capable of maintaining and storing instructions used by instruction-executing devices, for example, a non-transitory computer-readable storage medium. The computer-readable storage medium may include, but not limited to, an electrical storage device, a magnetic storage device, an optical storage device, an electromagnetic storage device, a semiconductor storage device or any suitable combination thereof. More specific examples of the computer-readable storage medium include (not an exhaustive list): a portable computer disc, a hard disc, a random access memory (RAM), a read-only memory (ROM), an erasable programmable read-only memory (EPROM or flash), a static random access memory (SRAM), a portable compacted disc read-only memory (CD-ROM), a digital versatile disc (DVD), a memory rod, a soft disc, a mechanical encoding device, a punched card such as that storing instructions thereon or a bump structure within a groove, and any suitable combination thereof. The computer-readable storage medium as used here is not interpreted as the transient signal per se, such as radio waves or other electromagnetic waves that are propagated freely, electromagnetic waves that are propagated by a waveguide or other transmitting media (for example, an optical pulse through a fiber-optical cable), or electrical signals transmitted via electrical wires.

The computer-readable program instructions as described here may be downloaded from the computer-readable storage medium to respective computing/processing devices, or to an external computer or an external storage device via a network, such as an Internet, a local area network, a wide area network and/or a wireless network. The network may comprise a copper transmission cable, an optical fiber transmission, a wireless transmission, a router, a firewall, a switch, a gateway computer and/or an edge server. The network adapter card or network interface in each computing/processing device receives computer-readable program instructions from the network and forwards the computer-readable program instructions to cause them to be stored in the computer-readable storage medium in the respective computing/processing devices.

The computer program instructions for executing operations of the present invention may be assembler instructions, instruction set architecture (ISA) instructions, machine instructions, machine-related instructions, microcode, firmware instructions, state-setting data, or source codes or target codes written in any combination of one or more programming languages, wherein the programming languages include object-facing programming languages, such as Smalltalk, C++, etc., and conventional procedural programming languages, such as “C” language or similar programming languages. The computer-readable program instructions can be fully executed on the user computer, partially executed on the user computer, executed as an independent software package, executed partially on the user computer and partially on a remote computer, or fully executed on a remote computer or server. Where a remote computer is involved, the remote computer may be connected to the user computer via any type of network, including a local area network (LAN) or a wide area network (WAN), or may be connected to an external computer (such as being connected via the Internet using the Internet service provider). In some examples, the state information of the computer-readable program instructions is used to customize an electronic circuit, such as a programmable logic circuit, a field programmable gate array (FPGA) or a programmable logic array (PLA), the electronic circuit being able to execute the computer-readable program instructions to realize the respective aspects of the present invention.

The respective aspects of the present invention are described here with reference to the flow charts and/or block diagrams of the method, apparatus (system) and computer program product according to the embodiments of the present invention. It shall be understood that each block in the flow charts and/or block diagrams and a combination of the blocks in the flow charts and/or block diagrams can be implemented by the computer-readable program instructions.

These computer-readable program instructions can be provided to the processor of a universal computer, a dedicated computer or any other programmable data processing device thereby produce a machine such that when these instructions are executed by the processor of the universal computer or other programmable data processing device, means for implementing the functions/actions prescribed in one or more blocks in the flow charts and/or block diagrams is produced. Alternatively, these computer-readable program instructions may be stored in a computer-readable storage medium, and these instructions cause the computer, programmable data processing device and/or other device to operate in a specific manner, and thus, the computer-readable medium storing the instructions include an article, comprising instructions for implementing the respective aspects of the functions/actions prescribed in one or more blocks in the flow charts and/or block diagrams.

The computer-readable program instructions may also be loaded onto a computer, other programmable data processing devices or other devices such that a series of operating steps are executed on the computer, other programmable data processing devices or other devices to generate a computer-implemented process, thereby causing the instructions executed on the computer, other programmable data processing devices, or other devices to implement the functions/actions prescribed in one or more blocks in the flow charts and/or block diagrams.

The flow charts and block diagrams in the figures display architectures, functions and operations that may be implemented by the system, method and computer program products according to the multiple examples of the present invention. In this regard, each block in the flow charts or the block diagrams may represent a module, a program segment or a part of the instructions, the module, program segment or part of instructions comprising one or more executable instructions for implementing the prescribed logic functions. In some implementations as alternatives, the functions labeled in the blocks may take place in a sequence different from that labeled in the figures. For example, two consecutive blocks may be actually executed substantially in parallel, and sometimes they may be executed in a reverse order, which depends on the related functions. It is also to be noted that each block in the block diagrams and/or flow charts and a combination of the blocks in the block diagrams and/or flow charts may be implemented by a hardware-based system specific for the execution of the prescribed functions or actions, or alternatively, may be implemented by a combination of the special hardware and computer instructions. It is well known to those skilled in the art that an implementation by means of hardware, an implementation by means of software, and an implementation by means of a combination of software with hardware are equivalent to one another.

The respective examples of the present invention have been described hereinabove. The above descriptions are illustrative instead of exhaustive, and the present invention is not limited to the respective examples as disclosed. Without deviation from the scope and spirits of the respective examples as described, many modifications and variations are obvious to those ordinary technicians skilled in the technical field. Selections of the terms in the text aim at best interpreting the principle and practical application of the respective examples or improving technologies in the market, or enabling other ordinary technicians skilled in the art to understand the respective examples revealed in the text. The scope of the present invention is defined by the attached claims.

1. A method for loading a webpage comprising the steps of:
in response to a request for loading a target webpage, loading the main document and the first-screen resource of the target webpage from a webpage server according to first-screen resource information of the target webpage that has been acquired, the first-screen resource information being used for identifying the first-screen resource of the target webpage; and
loading the first-screen resource to a corresponding position in the main document.

2. The method according to claim 1, wherein the step of loading the main document and the first-screen resource of the target webpage from the webpage server comprises the steps of:
transmitting a request for the target webpage to the webpage server, and transmitting a request for the first-screen resource of the target webpage to the webpage server according to locally stored first-screen resource information of the target webpage; and
receiving the main document and the first-screen resource of the target webpage returned from the webpage server.

3. The method according to claim 2, wherein the request for the target webpage includes the request for the first-screen resource of the target webpage.

4. The method according to claim 3, wherein the first-screen resource information is included in an HTML hyperlink tag directed to the target webpage, and the request for the target webpage is transmitted in response to a click on an HTML hyperlink corresponding to the HTML hyperlink tag.

5. The method according to claim 1, wherein the step of loading the main document and the first-screen resource of the target webpage from the webpage server comprises the steps of:
transmitting a request for the target webpage to the webpage server to trigger the webpage server to return the first-screen resource of the target webpage according to first-screen resource information of the target webpage locally stored in the webpage server while returning the main document of the target webpage; and
receiving the main document and the first-screen resource of the target webpage returned from the webpage server.

6. The method according to claim 1, wherein the method further comprises the step of:
prior to responding to the request for loading the target webpage, acquiring the first-screen resource information of the target webpage and storing it.

7. The method according to claim 1, wherein the first-screen resource information includes the resource address, resource type of the first-screen resource and a webpage identifier corresponding to the first-screen resource.

8. A client for loading a webpage comprising:
a resource loading unit for, in response to a request for loading a target webpage, loading the main document and the first-screen resource of the target webpage from a webpage server according to first-screen resource information of the target webpage which has been acquired, the first-screen resource information being used for identifying the first-screen resource of the target webpage; and
a first-screen loading unit for loading the first-screen resource to a corresponding position in the main document.

9. The client according to claim 8, wherein the resource loading unit comprises:
means for transmitting a request for the target webpage to the webpage server, and for transmitting a request for the first-screen resource of the target webpage to the webpage server according to locally stored first-screen resource information of the target webpage; and
means for receiving the main document and the first-screen resource of the target webpage returned from the webpage server.

10. The client according to claim 9, wherein the request for the target webpage includes the request for the first-screen resource of the target webpage.

11. The client according to claim 10, wherein the first-screen resource information is included in an HTML hyperlink tag directed to the target webpage, and the request for the target webpage is transmitted in response to a click on an HTML hyperlink corresponding to the HTML hyperlink tag.

12. The client according to claim 8, wherein the resource loading unit includes:
means for transmitting a request for the target webpage to the webpage server, to trigger the webpage server to return the first-screen resource of the target webpage according to first-screen resource information of the target webpage locally stored in the webpage server while returning the main document of the target webpage; and
means for receiving the main document and the first-screen resource of the target webpage returned from the webpage server.

13. The client according to claim 8, wherein the client further comprises means for acquiring first-screen resource information of the target webpage and storing it prior to responding to the request for loading the target webpage.

14. The client according to claim 8, wherein the first-screen resource information includes the resource address, resource type of the first-screen resource and a webpage identifier corresponding to the first-screen resource.

15. A programmable device comprising a memory and a processor, wherein the memory is used for storing instructions for controlling the processor to operate to perform a method for loading a webpage comprising the steps of:
in response to a request for loading a target webpage, loading the main document and the first-screen resource of the target webpage from a webpage server according to first-screen resource information of the target webpage that has been acquired, the first-screen resource information being used for identifying the first-screen resource of the target webpage; and
loading the first-screen resource to a corresponding position in the main document.

16. The programmable device according to claim 15, wherein the step of loading the main document and the first-screen resource of the target webpage from the webpage server comprises the steps of:
transmitting a request for the target webpage to the webpage server, and transmitting a request for the first-screen resource of the target webpage to the webpage server according to locally stored first-screen resource information of the target webpage; and
receiving the main document and the first-screen resource of the target webpage returned from the webpage server.

17. The programmable device according to claim 16, wherein the request for the target webpage includes the request for the first-screen resource of the target webpage.

18. The programmable device according to claim 17, wherein the first-screen resource information is included in an HTML hyperlink tag directed to the target webpage, and the request for the target webpage is transmitted in response to a click on an HTML hyperlink corresponding to the HTML hyperlink tag.

19. The programmable device according to claim 15, wherein the step of loading the main document and the first-screen resource of the target webpage from the webpage server comprises the steps of:
transmitting a request for the target webpage to the webpage server to trigger the webpage server to return the first-screen resource of the target webpage according to first-screen resource information of the target webpage locally stored in the webpage server while returning the main document of the target webpage; and
receiving the main document and the first-screen resource of the target webpage returned from the webpage server.

20. The programmable device according to claim 15, wherein the method further comprises the step of:
prior to responding to the request for loading the target webpage, acquiring the first-screen resource information of the target webpage and storing it.
